(19) United States
(12) Patent Application Publication
(10) Pub. No.: US 2022/0129762 A1
(43) Pub. Date: Apr. 28, 2022

(54) Removing Bias from Artificial Intelligence Models

(71) Applicant: Aible Inc., Foster City, CA (US)

(72) Inventors: Arijit Sengupta, San Francisco, CA (US); Jonathan Wray, San Francisco, CA (US)

(21) Appl. No.: 17/232,593

(22) Filed: Apr. 16, 2021

Related U.S. Application Data
(60) Provisional application No. 63/104,828, filed on Oct. 23, 2020.

(51) Int. Cl. G06N 3/12; G06N 20/00

(52) U.S. Cl. CPC G06N 3/126; G06N 20/00

(57) ABSTRACT

Data is received characterizing a population and a target trait characteristic for selecting candidates from the population. The population is segmented into at least a first subpopulation and a second subpopulation. A first number of candidates is selected from the first subpopulation and using a first model. The first number of candidates is selected according to the target trait characteristic. The first model having been trained using a first training population in which all members of the first training population are part of the first class of the two or more classes. A second number of candidates is selected from the second subpopulation and using a second model. The second model having been trained using a second training population in which all members of the second training population are part of the second class of the two or more classes. Related apparatus, systems, techniques and articles are also described.

### CROSS REFERENCE TO RELATED APPLICATION

This application claims priority to and the benefit under 35 U.S.C. § 119(e) to U.S. Provisional Patent Application No. 63/104,828 filed Oct. 23, 2020, the entire contents of which is hereby expressly incorporated by reference herein.

### TECHNICAL FIELD

The subject matter described herein relates to training and utilizing artificial intelligence without bias.

### BACKGROUND

Algorithmic bias describes systematic and repeatable errors in a computer system that create unfair outcomes, such as privileging one arbitrary group of users over others. Bias can emerge due to many factors, including the design of algorithms, unintended or unanticipated use or decisions relating to the way data is coded, collected, selected or used to train the algorithm. Algorithmic bias can be found across platforms, including search engine results and social media platforms, and can have impacts ranging from inadvertent privacy violations to reinforcing social biases of race, gender, sexuality, and ethnicity.

### SUMMARY

Some implementations of the current subject matter relate to a platform that enables artificial intelligence model creation in which, rather than determining a prediction across a given population, the population is segmented by a particular trait into subpopulations. An objective for the trait, such as a specified ratio or amount a model should select from the respective sub-populations, can be specified. The resulting artificial intelligence model can perform predictions across each sub-population separately while also observing the specified ratio or amount for the trait, which can enable removing bias for that trait from the model.

In an aspect, data is received characterizing a population and a target trait characteristic for selecting candidates from the population. The population includes members and each member of the population includes a respective trait classifiable into one of two or more classes. The population is segmented into at least a first subpopulation and a second subpopulation. The segmenting is such that all members of the first subpopulation are part of a first class of the two or more classes and all members of the second subpopulation are part of a second class of the two or more classes. A first number of candidates is selected from the first subpopulation and using a first model. The first number of candidates is selected according to the target trait characteristic. The first model having been trained using a first training population in which all members of the first training population are part of the first class of the two or more classes. A second number of candidates is selected from the second subpopulation and using a second model. The second number of candidates is selected according to the target trait characteristic. The second model having been trained using a second training population in which all members of the second training population are part of the second class of the two or more classes.

One or more of the following features can be included in any feasible combination. For example, the population can include members of a protected class. The respective trait can include a characteristic of a person. The trait can be classifiable into only the first class or the second class. The trait can classifiable into three or more classes. The segmenting can further include segmenting the population into at least a third subpopulation, and all members of the third subpopulation can be part of a third class of the three or more classes. A third number of candidates can be selected from the third subpopulation using a third model. The third number of candidates can be selected according to the target trait characteristic. The third model can have been trained using a third training population in which all members of the third training population are part of the third class of the three or more classes.

The target trait characteristic can include a maximum allowed number of one of the first class and/or the second class, a minimum allowed number of the first class and/or the second class, or a ratio between at least the first class and the second class. The first model can include a set of submodels, and each submodel can have been trained using a respective different resource constraint. Selecting the first number of candidates can include receiving a resource level and selecting a corresponding submodel from the set of submodels forming the first model. The selected submodel can be associated with the received resource level.

The selecting the first number of candidates can be further according to an impact function. The impact function can characterize maximizing profits for a business, maximizing growth for the business, maximizing revenue for the business, and/or minimizing resource consumption for the business.

The first model can be continuously trained. User feedback regarding the selected first number of candidates can be received. The first model can be retrained using the user feedback and the selected first number of candidates.

Each member of the population can include a second respective trait classable into two or more additional classes including a third class and a fourth class. The first subpopulation can be segmented into a third subpopulation and a fourth subpopulation. The segmenting can be such that all members of the third subpopulation are part of the third class and all members of the fourth subpopulation are part of the fourth class. The second subpopulation can be segmented into a fifth subpopulation and a sixth subpopulation. The segmenting can be such that all members of the fifth subpopulation are part of the third class and all members of the sixth subpopulation are part of the fourth class. The selecting, from the first subpopulation and using the first model, of the first number of candidates from the first subpopulation can include selecting, from the third subpopulation, a third number of candidates according to a second target trait characteristic, and selecting, from the fourth subpopulation, a fourth number of candidates according to the second target trait characteristic. A total number of the third number of candidates and the fourth number of candidates can equal the first number of candidates.

The first model can include a set of submodels, each submodel trained using a respective different resource constraint. Selecting the third number of candidates can include receiving a resource level and selecting a corresponding submodel from the set of submodels forming the first model. The selected submodel can be associated with the received resource level. Selecting the fourth number of candidates can include selecting the second corresponding submodel from the set of submodels forming the first model.

Non-transitory computer program products (i.e., physically embodied computer program products) are also described that store instructions, which when executed by one or more data processors of one or more computing systems, causes at least one data processor to perform operations herein. Similarly, computer systems are also described that may include one or more data processors and memory coupled to the one or more data processors. The memory may temporarily or permanently store instructions that cause at least one processor to perform one or more of the operations described herein. In addition, methods can be implemented by one or more data processors either within a single computing system or distributed among two or more computing systems. Such computing systems can be connected and can exchange data and/or commands or other instructions or the like via one or more connections, including a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims.

### DESCRIPTION OF DRAWINGS

FIG. 1A illustrates an example user interface for a model building and analysis platform according to some aspects of the current subject matter;

FIG. 1B is a process flow diagram illustrating an example process of selecting members from a population according to a specified condition on a trait of members of the population and according to some example implementations of the current subject matter;

FIG. 2 is a process flow diagram illustrating an example implementation of assessing the performance of multiple models under multiple different constraints;

FIG. 3 is a system block diagram illustrating an example implementation of a system for training, assessing, and deploying a set of resourcing models;

FIG. 4 is a diagram illustrating an example visualization of outputs provided by several models as a function of a resourcing variable;

FIG. 5 is a diagram illustrating an example visual representation of a feasible performance region; and

FIG. 6 illustrates another example user interface for the example model building analysis platform.

Like reference symbols in the various drawings indicate like elements.

### DETAILED DESCRIPTION

As noted above, bias in algorithms, including artificial intelligence can be unintended and create unfair or undesirable outcomes, such as privileging one arbitrary group of users over others. In artificial intelligence, because the algorithms learn from training data, the bias within the training data can be learned by the algorithm. Moreover, bias within an artificial intelligence algorithm can create a feedback loop if data collected for an algorithm results in real-world responses, which are fed back into the algorithm, for example, as occurs in continuous training algorithms. This can amplify and reinforce the bias including the unfair and/or undesirable outcomes.

There have been several attempts to create methods and tools that can detect and observe biases within an algorithm. Many of these attempts focus on tools that can be typically applied to the training data used by the program rather than the algorithm's internal processes. But attempting to remove bias from an artificial intelligence algorithm can be challenging because while the artificial intelligence can be prohibited from explicitly considering a certain trait (such as race), the artificial intelligence may still focus on other qualities that can serve as a proxy for the prohibited trait. For example, prohibiting an algorithm that informs hiring decisions from considering race may result in the algorithm considering other factors such as educational background (e.g., the name of the college a candidate attended) and socio-economic indicators that may serve as a proxy for race.

Some implementations of the current subject matter relate to a platform that enables artificial intelligence model creation in which, rather than determining a prediction across a given population, the population is segmented by a particular trait into sub-populations. For example, a population of job candidates can be segmented by age into adult (e.g., 18 years and older), and minor (below 18 years). An objective for the trait (e.g., trait target), such as a specified ratio or amount, can be specified. The resulting artificial intelligence model can perform predictions across each sub-population separately while also observing the specified condition for the trait (e.g., ratio, amount, maximum, minimum, and the like). By segmenting the population according to the prohibited trait and then specifically selecting candidates from the subpopulations according to a condition on the trait, the effect of the artificial intelligence models relying on other factors that may serve as a proxy for the trait can be reduced.

As an example, consider an artificial intelligence algorithm that includes a predictive model for selecting candidates for interviewing from a pool of candidates. The predictive model selects the candidates by predicting which candidates should be interviewed to maximize company profits (such predictive model can favor qualified candidates that are likely to accept a job offer and stay with the company for at least 5 years over candidates that are not likely to accept a job offer or would leave within 5 years of employment). Using some implementations of the current subject matter, the population of candidates can be segmented by a trait (e.g., age) into sub-populations (e.g., adults and minors). The predictive model can have sub-models that have been trained for each sub-population. When the model is utilized to predict which candidates to interview from the pool of candidates, a ratio of 80% adult and 20% minor can be specified, for example. The model can then predict candidates from the pool in a manner that matches the ratio (e.g., if 10 candidates are interviewed, then the model would select 8 (80%) adults and 2 (20%) minors).

The current subject matter can be applied to any population where bias may be a concern. For example, some implementations of the current subject matter can consider any number of protected classes as the population trait by which to segment. For example, the following classes are protected classes: race, color, religion, national origin, sex, disability, and familial status. Moreover, the current subject matter can be applied to any decision making where bias may be a concern. For example, decisions within human resource departments such as for recruiting including screening, interviewing and placing workers; as well as employee relations such as payroll, benefits, and training. Additional examples of decisions where bias may be a concern include healthcare decisions, housing decisions, leasing decisions, school decisions, affirmative action, mortgage approval decisions, criminal sentencing, and many others.

Because the current subject matter enables a user to input the desired amount or ratio for a given trait, the current subject matter can enable removing bias for that trait from the model. Instead of providing results that may be biased based on an underlying bias in the training data (which, for example, is present as a result of human behavior and bias), the current subject matter provides for artificial intelligence algorithms (e.g., predictive analytics and modeling) that explicitly sets a condition on the result with respect to the trait, such as a floor or minimum threshold for the trait. And in implementations where continuous training is utilized, the models can learn over time to better identify the value within each subgroup, which does not occur where a single model is used to predict from an unsegmented population. For example, where the population is segmented into adults and minors, the sub-model associated with the minors will learn to better identify the value (e.g., to maximize company profits) from the candidate pool that are minors.

Some implementations can include segmenting the population for more than one trait. The population can be segmented by a first trait, and the resulting subpopulations can then each be segmented by a second trait. For example, in order to counter bias for both age (e.g., adult or minor), and gender (male, female, other), the population can initially be segmented according to age into two subpopulations (e.g., adult and minor), and those subpopulations can then be segmented according to gender into three or more respective sub-subpopulations (male, female, other). In this example, there would be six total subpopulations, corresponding to: adult-male, adult-female, adult-other, minor-male, minor-female, and minor-other. In some implementations, each sub-subpopulation can be analyzed by a respective model trained on a dataset with a population of only their respective trait values. For example, a model according to the adult-male sub-subpopulation can have been trained on data of a training population in which each member of the training population belongs to the adult-male subpopulation. Some implementations can include segmenting by two, three, fourth, or more traits, and each trait can include corresponding two or more possible trait values or classes (e.g., adult or minor; male, female, other).

In some implementations, each sub-model of the model can be implemented as an efficient frontier, which is described in more detailed below. The efficient frontier enables each sub-model to provide optimal predictive results in view of a specified resource amount or constraint. For example, if a business is willing to spend 10 man-hours interviewing versus 20 man-hours, a predictive model utilizing efficient frontiers can provide the optimal prediction for both scenarios. In some implementations, two or more subpopulations (or subpopulations of the subpopulation, as in the case of segmenting by more than one trait) can utilize the same efficient frontier model.

In some implementations, the efficient frontier can include a set of models where each model in the set is the optimal model for a given resource level or constraint. Models that are optimal for lower resource levels can be optimal where resources are limited whereas models that are optimal for higher resource levels can be optimal where resources are not so limited. In some implementations, in the scenario where resources are not so limited, the models that are optimal for the higher resource level may not be initially used on a given input data (e.g., population). Instead the models that are optimal at lower resource levels may be utilized with the initial portion of the input population. As increasing records of the input data (e.g., population) are processed, the models (or model) that is used to process the input can change to different models, specifically those models that are optimal for higher resource levels as they perform better the deeper into the population the processing is performed. In other words, as more records are processed, the models selected to process a given record can change such that earlier records are processed by models that are optimal for lower resource levels and later records are processed by models that are optimal for higher resource levels. In other words, for a given series of records, a best model along the efficient frontier would handle predictions until it is overtaken by another model, moving along the efficient frontier.

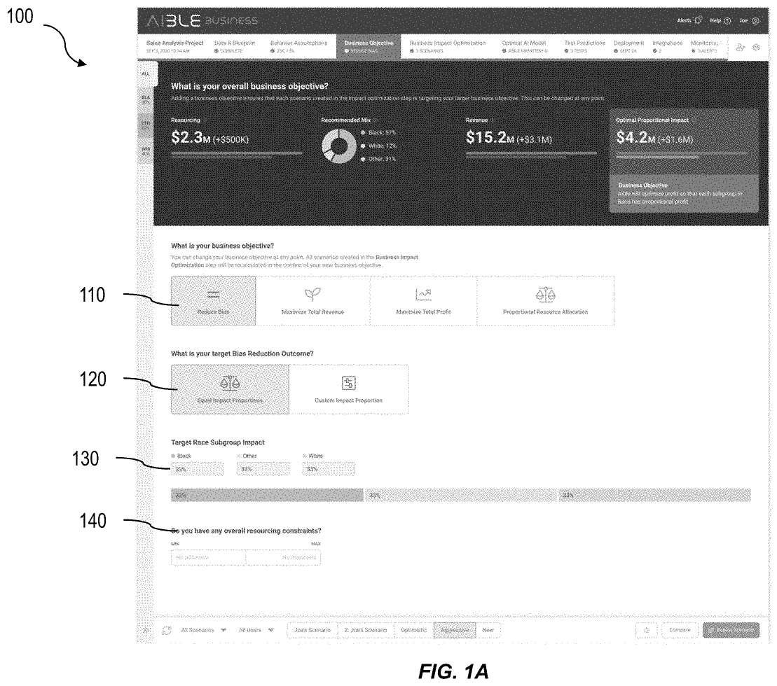

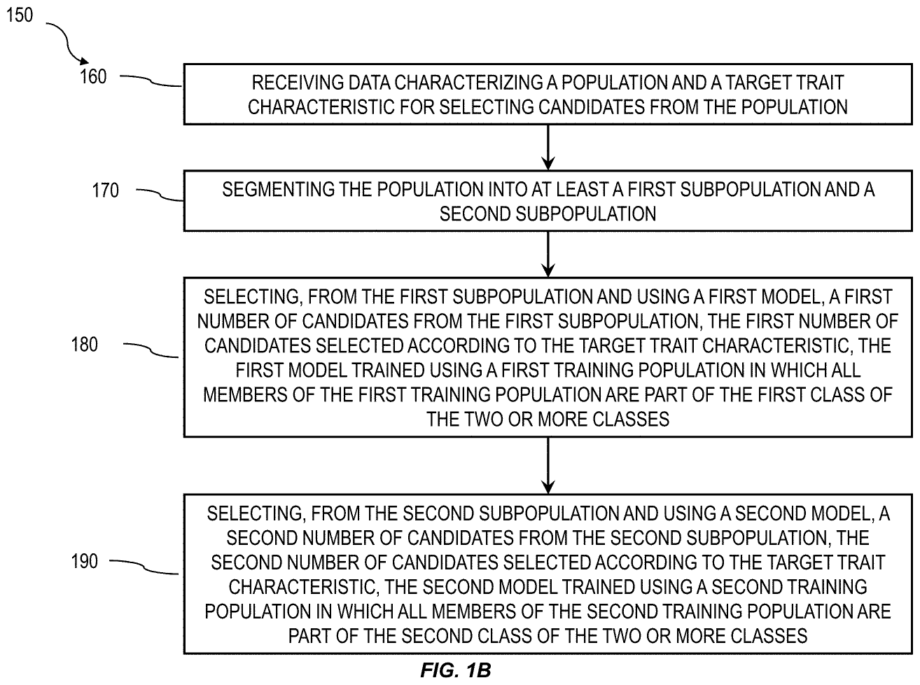

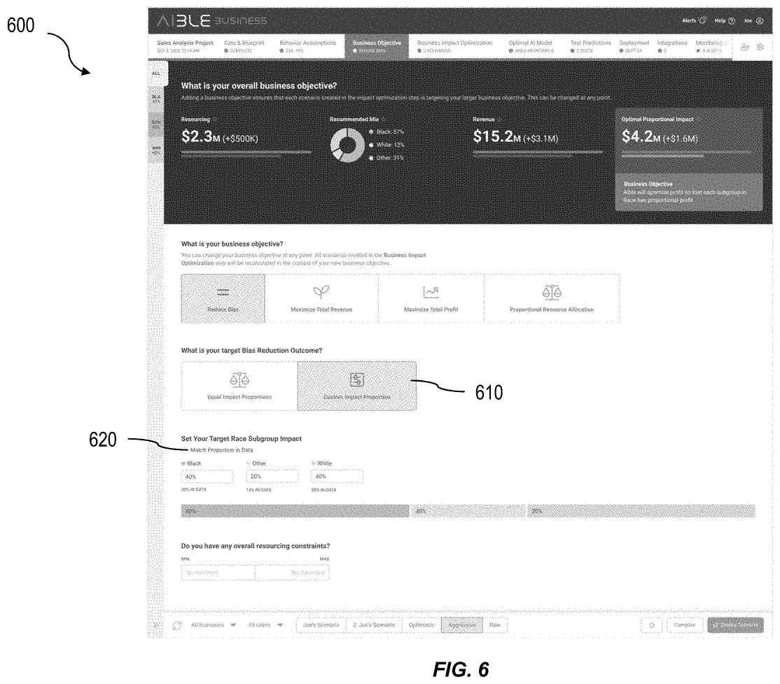

FIG. 1A illustrates an example user interface 100 for a model building and analysis platform according to some aspects of the current subject matter. The interface enables a user to select, at 110, the business objective from one of reducing bias, maximizing total revenue, maximize total profit, and proportional resource allocation. When the selected business objective is to reduce bias, the interface enables a user to select providing an equal impact proportion or a custom impact proportion at 120. The user can also select the target subgroup impact at 130. The user interface 100 illustrates one example implementation where an explicit goal for the proportions can be set. As shown, a proportional benefit is expected to be received by the company from hires out of each subgroup. Other implementations are possible including setting minimums rather than absolutes so that no group drops below a given bound. Similarly an upper bound can be set to prevent the artificial intelligence from focusing too heavily on one group. While the example user interface 100 illustrates a set proportional output, in some implementations a target can be set to balance the input to 20% minors, number of interviews (2 minor, 8 adult) (e.g., hiring unconstrained) as compared to interviews set proportionally to achieve a set outcome target of hiring 20% minors (e.g., so interview 10 minors, 12 adults), hire (1 minor, 4 adults), because minors are hired at lower frequency so more were interviewed. At 140, the user can specify a minimum or maximum resource constraint. FIG. 6 illustrates another example user interface 600 for the example model building analysis platform. In FIG. 6, the custom impact proportion is selected at 610. Further, a check box 620 is included which enables the user to match the subgroup impact to their data (e.g., population).

FIG. 1B is a process flow diagram illustrating an example process 150 of selecting members from a population according to a specified condition on a trait of members of the population and according to some example implementations of the current subject matter. The process can segment the population according to the trait into subpopulations. The segmentation can occur such that there is a subpopulation for each value the trait can take (e.g., minor or adult). In some implementations, for each subpopulation, a respective model trained with a dataset that includes members having the respective trait value can be utilized.

At 160, data characterizing a population and a target trait characteristic for selecting candidates from the population is received. The population can include members and each member of the population can include a respective trait classifiable into one of two or more classes. For example, if the population includes individuals (e.g., people), and the trait includes age, then the trait can be classifiable into two or more classes or value, such as minor (e.g., less than 18 years old) or adult (e.g., 18 years and older). In some implementations, there can be more than two classes or values for any trait, for example, age trait can be classifiable into three classes or values, such as minor (e.g., less than 18 years old), adult (18 years old and older but less than 65), and senior (65 years and older).

The selection of candidates from the population can be in relation to any number of decisions including those which bias in the decision may be a concern. For example, selecting candidates to interview from a pool of job applicants; selecting mortgages to review from a pool of mortgage applications; and the like. The decision can relate to a final hiring decision (e.g., whether or not to hire a candidate) or can relate to an amount of resources or opportunities to dedicate. For example, the decision can relate to whether or not to interview a candidate.

The target trait characteristic for selecting candidates from the population can include a condition on the trait. For example, using the example where the trait is age and the population includes a pool of job applicants, the target trait characteristic can specify that 80% of those interviewed be adult, and 20% be minors. The condition can be on a number, ratio, a percentage of candidates having a given trait class (e.g., that are minor) that are selected, and the like. Example conditions can include a maximum, a minimum, a ratio (e.g., between two classes of the trait), percentage and the like.

At 170, the population can be segmented into at least a first subpopulation and a second subpopulation. The segmenting can be such that all members of the first subpopulation are part of a first class of the two or more classes and all members of the second subpopulation are part of a second class of the two or more classes. For example, using the example where the trait is age, the population can be segmented into those members that are adult, and those that are minors.

At 180, a first number of candidates from the first subpopulation is selected using a first model. For example, a number of job applicants in the adult subpopulation can be selected for interviewing. The first number of candidates can be selected according to the target trait characteristic. For example, the number of job applications selected for interviewing from the adult subpopulation can be a set number (for example, 8 of the 10 possible interview opportunities).

The first model can include an artificial intelligence model such as a predictive model, and can have been trained using a first training population in which all members of the first training population are part of the first class of the two or more classes. For example, the model corresponding to the adult subpopulation can have been trained on a training population that included only members that would be classified into the adult subpopulation (e.g., does not contain any minors).

At 190, a second number of candidates is selected from the second subpopulation and using a second model. For example, a number of job applicants in the minor subpopulation can be selected for interviewing. The second number of candidates can be selected according to the target trait characteristic. For example, the number of job applicants selected for interviewing from the minor subpopulation can be a set number (for example, 2 of the 10 possible interview opportunities).

The second model can include an artificial intelligence model such as a predictive model, and can have been trained using a second training population in which all members of the second training population are part of the second class of the two or more classes. For example the model corresponding to the minor subpopulation can have been trained on a training population that included only members that would be classified into the minor subpopulation (e.g., does not contain any adults).

In some implementations, the population includes members of a protected class. For example, federal US law protects the following classes: race, color, religion, national origin, sex, disability, and familial status. Other protected classes can be used as well, for example, classes protected by state law, or by company policy.

The trait can include a characteristic of a person. For example, age, race, color, religion, national origin, sex, disability, and familial status. Other traits can be used as well. In some implementations, the trait is classifiable into only the first class or the second class. For example, age can be considered to have two classes that include minors (under 18) and adult (over 18). In some implementations, the trait is classifiable into three or more classes. For example, age can be considered to have three classes that include minors (under 18), adult (over 18 but less than 65), and senior (65 and over).

In some implementations, the segmenting further includes segmenting the population into at least a third subpopulation and all members of the third subpopulation are part of a third class of the three or more classes. A third number of candidates can be selected from the third subpopulation and using a third model. The third number of candidates selected according to the target trait characteristic. The third model can have been trained using a third training population in which all members of the third training population are part of the third class of the three or more classes.

In some implementations, the target trait characteristic can include a maximum allowed number of one of the first class and/or the second class, a minimum allowed number of the first class and/or the second class, or a ratio between at least the first class and the second class. Other conditions can be used.

In some implementations, the first model includes a set of submodels, each submodel trained using a respective different resource constraint. For example, the first model can include an efficient frontier model in which each submodel is optimal for a different resource or constraint level. In such implementations, selecting the first number of candidates can include receiving a resource level and selecting a corresponding submodel from the set of submodels forming the first model. The selected submodel can be the submodel that is associated with the received resource level.

In some implementations, the selecting the first number of candidates can be according to an impact function. The impact function can characterize maximizing profits for a business, maximizing growth for the business, maximizing revenue for the business, and/or minimizing resource consumption for the business. For example, an impact function can be considered as the sum of the count or probability of true positive, true negative, false positive, and false negative occurrences multiplied by their respective value (or cost where the value is negative).

In some implementations, the first model is continuously trained. User feedback regarding the selected first number of candidates can be received. The first model can be retrained using the user feedback and the selected first number of candidates.

In some implementations, each member of the population can include a second respective trait classable into two or more additional classes including a third class and a fourth class. For example, if a population is first segmented by age into adult and minor, the population can be segmented by criminal history into felon and non-felon by segmenting each subpopulation according to criminal history, thereby resulting in four separate sub-subpopulations. For example, the first subpopulation can be segmented into a third subpopulation and a fourth subpopulation. The segmenting can be such that all members of the third subpopulation are part of the third class and all members of the fourth subpopulation are part of the fourth class. The second subpopulation can be segmented into a fifth subpopulation and a sixth subpopulation. The segmenting can be such that all members of the fifth subpopulation are part of the third class and all members of the sixth subpopulation are part of the fourth class. The selecting, from the first subpopulation and using the first model, of the first number of candidates from the first subpopulation can include selecting, from the third subpopulation, a third number of candidates according to a second target trait characteristic, and selecting, from the fourth subpopulation, a fourth number of candidates according to the second target trait characteristic. A total number of the third number of candidates and the fourth number of candidates equals the first number of candidates.

In some implementations, the first model can include a set of submodels, and each submodel can have been trained using a respective different resource constraint. Selecting the third number of candidates can include receiving a resource level and selecting a corresponding submodel from the set of submodels forming the first model. The selected submodel can be associated with the received resource level. Selecting the fourth number of candidates can include selecting the second corresponding submodel from the set of submodels forming the first model.

Although a few variations have been described in detail above, other modifications or additions are possible. While the above description includes a single trait that can take a binary value (e.g., adult or minor), the current subject matter can be applied to traits having more than two values. For example, if a trait has N possible values, then the current subject matter can create N separate subgroups, each subgroup corresponding to a respective value. In addition, populations can be segmented by more than one trait. For example, a population can be first segmented by the first trait, and then those subgroups can be segmented by a second trait. For example, if there are two traits, each having 2 possible values (e.g., adult/minor, felony-conviction/no-conviction), then the current subject matter can determine four subgroups.

The subject matter described herein provides many technical advantages. For example, some implementations of the current subject matter do not prescribe arbitrary actions that could be detrimental to overall firm objectives. While any artificial constraint does have the ability to limit performance, the nature of this approach will more often than not overcome the constraints to identify unique value that would otherwise be missed using traditional methods. In the hiring example, the artificial intelligence will learn to identify top talent from all potential talent pools, giving the firm an advantage in hiring the best candidates from any background. The bounds provided give the system limits with which it must abide, but it is otherwise free to pursue the maximum benefit for the company.

Some implementations of the current subject matter can train and assess multiple models with multiple different constraints on the input parameters. And the multiple models can be treated as a single model (also referred to as an efficient frontier). For example, each model can be trained with each of the different constraints on a given input parameter and the performance of each model can be assessed under each of the different constraints. The assessment of the performance of the models can be provided in a visualization illustrating a feasible performance region of the models. For example, the feasible performance region can include a boundary representing, for the set of models trained under the different constraints, predictions as a function of the given constrained parameter and an indication of the model that produced a given prediction. Given a constraint, the model most appropriate for the given constraint can be selected and deployed to perform predictions under the given constraint.

Accordingly, some implementations of the current subject matter can provide improved predictions by training and assessing multiple models under different constraints and providing an intuitive representation of the models and their performance under the different constraints. By training and assessing multiple models under different constraints and providing an intuitive representation of the performance of the models under the different constraints, the model most appropriate for a given operational constraint can be selected and deployed.

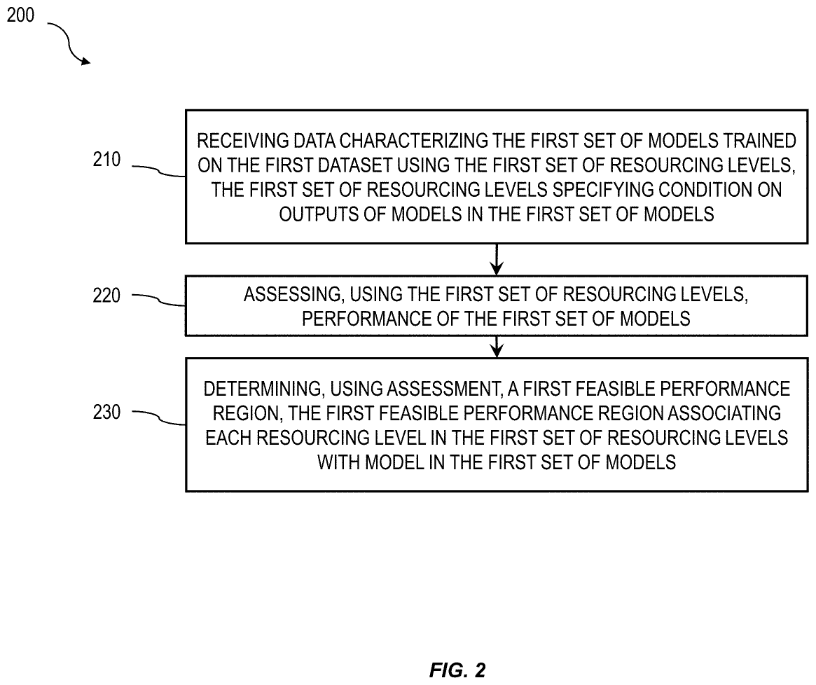

FIG. 2 is a process flow diagram 200 illustrating an example implementation of assessing the performance of multiple models under multiple different constraints.

At 210, data characterizing a set of models, M={M₁, . . . , Mₖ} (where Mᵢ∈M is a model), trained using a set of resourcing levels (e.g., constraints and/or the like), C={c₁, . . . , cₚ} (where cᵢ∈C is a constraint) can be received. In some cases, the set of models can be represented as an ensemble model. An ensemble model can be allow for interaction with the set of models by interacting with the ensemble model. For example, providing an input data entry x^{(j)} from a dataset Dₙ={x⁽¹⁾, . . . , x⁽ⁿ⁾} where n is the number of variables (e.g., columns and/or the like) associated with respective entries in the dataset and j=1, . . . , n, to an ensemble model M including a set of models {M₁, . . . , Mₖ} can be the equivalent of providing the data entry as input to each model in the set of models (e.g., M(x^{(j)})={M₁(x^{(j)}), . . . , Mₖ(x^{(j)})}). The set of constraints can specify a condition on a variable of the models. Each model (e.g., submodel and/or the like) in the set of models (e.g., ensemble model) can be trained using at least one constraint in the set of constraints. For example, the specified condition on the variable of the model can limit the space of possible solutions provided by the set of models. For example, for a given input x^{(j)}=(x₁^{(j)}, . . . x_{d}^{(j)}), where x^{(j)}∈R^{d} is a d-dimensional vector, each model can provide an output, such as a classification, Mᵢ(x^{(j)})=yᵢ^{(j)} (where yᵢ^{(j)}∈{positive, negative} corresponds to a “positive” (e.g., a classification as a positive class) or a “negative” (e.g., a classification as a negative class)). As will be discussed in detail below, a constraint can, for example, constrain a value of a variable in an entry of a dataset used to train the set of models.

In some cases, the output can specify what is being tested for, such as an input in a medical classifier being classified in the positive class as a tumor or the negative class as not a tumor or an input to an email classifier being classified in the positive class as a spam email or the negative class as not a spam email. In some cases, the specified constraint can limit the number of “positive” classifications output by a model, the number of “negative” classifications output by a model, and/or the like. For example, if the variable includes capacity and the constraint specifies a condition on capacity, such as a maximum possible capacity, the aggregate number of “positive” classes provided by each model can be below the capacity constraint. For example, in a hospital admissions classifier (e.g., model and/or the like), the constraint can include the number of beds available to patients in the hospital, where a single patient can occupy a bed. The variable can include the number of currently admitted patients and a new patient can be classified in the positive class, to be admitted, or in the negative class, not to be admitted. But based on the constraint on the variable, the number of admitted patients cannot exceed the number of hospital beds. If, for example, the number of patients equals the number of hospital beds, currently admitted lower risk patients can be released early to free up beds for new patients with a risk greater than the lower risk patients.

At 220, the performance of the set of models can be assessed. For example, each class provided by a classifier can include an indication of whether the classification was a true classification (e.g., a true positive TP, a true negative TN, and/or the like) or a false classification (e.g., a false positive FP, a false negative FN, and/or the like). Each classification (e.g., true classification, false classification, and/or the like) can be associated with a value. For example, a “true positive” can be associated with a value TPᵥ, a “true negative” can be associated with a value TNᵥ, a “false positive” can be associated with a value FPᵥ, and a “false negative” can be associated with a value FNᵥ. When given a set of inputs, the set of models can provide a classification for each input. For example, given a set of inputs {x⁽¹⁾, . . . , xⁿ} and an ensemble model (e.g., a set of constrained models and/or the like) M={M₁, . . . , Mₖ}, each constrained model Mᵢ can provide a set of predictions Yᵢ={yᵢ⁽¹⁾, . . . , yᵢ⁽ⁿ⁾} such that the set of constrained models M provides a set of sets of predictions, M({x⁽¹⁾, . . . , x⁽ⁿ⁾})={M₁({x⁽¹⁾, . . . , x⁽ⁿ⁾}), . . . , Mₖ({x⁽¹⁾, . . . , x⁽ⁿ⁾})}={Y₁, . . . , Yₖ}={{y₁⁽¹⁾, . . . , y₁⁽ⁿ⁾}, . . . , {yₖ⁽¹⁾, . . . , yₖ⁽ⁿ⁾}}. For example, as discussed above, each prediction yᵢ^{(j)} can include an indication whether the input x^{(j)} was correctly classified by model Mᵢ (e.g., a “true”) or incorrectly classified by model Mᵢ (e.g., a “false”). The predictions can be aggregated over i∈{1, . . . , k} and j∈{1, . . . , n}. The aggregated predictions can include, for example, a count of “true positives” TP_{c}, a count of “true negatives” TN_{c}, a count of “false positives” FP_{c}, and a count of “false negatives” FN_{c}. For example, a constraint can provide a condition on one or more of TP_{c}, TN_{c}, FP_{c}, FN_{c}, and/or the like.

In some cases, the frequency with which a model was correct when predicting the “positive” class, or precision

$$( e . g . , Precision = \frac{T {P}_{c}}{T {P}_{c} + F {P}_{c} \vert} ) ,$$

can be used to assess the performance of the model. In some cases, the number of “positive” labels correctly identified by the model, or recall

$$( e . g . , Recall = \frac{T {P}_{c}}{T {P}_{c} + F {N}_{c}} ) ,$$

can be used to assess the performance of the model. In some cases, the fraction of predictions that the model correctly predicted, or accuracy

$$( e . g . , A ccuracy = \frac{T {P}_{c} + T {N}_{c}}{T {P}_{c} + T {N}_{c} + F {P}_{c} + F {N}_{c}} ) ,$$

can be used to assess the performance of the model. But, assessing the performance of a model by optimizing on these metrics may not necessarily provide the best model for a given set of constraints. For example, in some cases, it can be desirable to assess the performance of the models by determining functions such as impact (e.g., Impact=TP_{c}·TPᵥ+TN_{c}·TNᵥ+FP_{c}·FPᵥ+FP_{c}·FPᵥ). In some cases, impact can include the aggregation over classifications of the count of classifications weighted by the value of respective classifications. In some cases, custom training and evaluation functions or metrics other than precision, recall, accuracy, loss, and/or impact can be used, including, for example, custom optimization functions. In some cases, a set of custom optimization functions can be used to generate the set of models. In some cases, a set of custom optimization functions can be used to assess the performance of the set of models by evaluating, for a given input data entry and/or set of constraints specifying a condition on a variable of the input data entry, respective outputs provided by the sets of models.

Further to the boolean case described above (e.g., model Mᵢ outputting either “positive” or “negative” for a given input), some implementations of the current subject matter can include multivariate models Mᵢ, such that the output of the model includes three or more possible output values. For example, given a model Mᵢ, an input x^{(j)}, where x^{(j)} can include an element of the dataset Dₙ, and an output dimension dₒ, where dₒ≥3, the model can output Mᵢ(x^{(j)})=yᵢ^{(j)}, where yᵢ^{(j)}∈{class₁, . . . , class_{d}_{ₒ}}. For example, if dₒ=3, then the output yᵢ^{(j)} can include either class₁, class₂, or class₃. p Then, the performance of each model Mᵢ∈M can be provided in a confusion matrix characterizing, for each possible output, a value of a respective output given a respective actual value. For example, when the output of model Mᵢ on input x^{(j)} is yᵢ^{(j)} (e.g., Mᵢ(x^{(j)})=yᵢ^{(j)}), the output can be compared with the actual value being predicted and the value vₛₜ∈R (e.g., vₛₜ can include a real number and/or the like) can be provided, where s can include the predicted class and t can include the actual (e.g., true and/or the like) value.

As illustrated in the confusion matrix below, the output yᵢ^{(j)} of model Mᵢ on input x^{(j)} can include class₁, class₂, or class₃. The actual value can include class₁, class₂, or class₃. When the output yᵢ^{(j)} of model Mᵢ on input x^{(j)} is class₁, the confusion matrix can include three different values characterizing the performance of the model. For example, when the output yᵢ^{(j)}=class₁ and the actual value is class₁ a value of v₁₁ can be obtained; when the output y₁^{(j)}=class₁ and the actual value is class₂ a value of v₁₂ can be obtained; and when the output yᵢ^{(j)}=class₁ and the actual value is class₃ a value of v₁₃ can be obtained.

confusion matrix actual class₁ class₂ class₃ class₁

v₁₁ v₁₂ v₁₃ yᵢ^{(j)} class₃ v₂₁ v₂₂ v₂₃ class₃ v₃₁ v₃₂ v₃₃

To illustrate this example further, suppose the three classes are “red”, “yellow”, and “green”, corresponding to a stoplight, and the problem includes predicting the color of the light by a self-driving car. Then class₁ can correspond to “red”, class₂ can correspond to “yellow”, and class₃ can correspond to “green”. When a given model Mᵢ predicts the color of the stoplight as “red”, the possible actual values can include “red”, “yellow”, and “green”, and the confusion matrix can include a characterization of the performance of the model. For example, if the actual value is “red”, then v_{red,red} can be characterized as performing well. When the actual value is “yellow”, then v_{red,yellow} can be less than v_{red,red}, but not as low as v_{red,green} when the actual value is “green”, since a car stopping at a yellow light can be expected under ordinary driving conditions (e.g., the car being driven by a human), but a car stopping at a green light can be out of the ordinary. Similarly, a value characterizing the performance of the prediction can be provided for each pair of outputted class and respective actual value.

At 230, the feasible performance region can be determined using the assessment of the performance of the set of models ascertained at 220. For example, as described above, the performance of each model can be assessed. The assessment of performance can be used to determine which model Mᵢ can be used for different values of the constrained variable xₕ^{(j)}, x^{(j)}=(x₁^{(j)}, . . . , xₕ^{(j)}, . . . , x_{d}^{(j)}). For example, model M₁ may provide optimal performance for a value of the constrained variable xₕ^{(j)} less than a first threshold T₁, model M₂ may provide optimal performance for a value of the constrained variable xₕ^{(j)} greater than the first threshold T₁ but less than a second threshold T₂, and model M₃ may provide optimal performance for a value of the constrained variable xₕ^{(j)} greater than the second threshold T₂. In some cases, the feasible performance region can be determined by interpolating between the accuracy of the generated models to define a region, border, and/or the like. For example, a metric (e.g., accuracy, recall, precision, impact, and/or the like) can be determined for each model in the generated set of models. The respective metrics can be discrete elements (e.g., points and/or the like) of the constraint space (e.g., the number line representing the constraint and/or the like). The respective discrete elements can be used to interpolate, for example, a continuous boundary and/or region. In some cases, the feasible performance region can be determined by bounding the optimal points in a range of possible constraint values for respective (e.g., every) model in the set of models.

The feasible performance region of the set of models as a function of the resourcing level can be displayed. As will be discussed below, the displayed feasible performance region can include a visualization of, for example, the model Mᵢ that provides optimal performance in a given interval of the resourcing variable, the value of the custom training and evaluation function or metric that is optimized by the model Mᵢ, and/or the like.

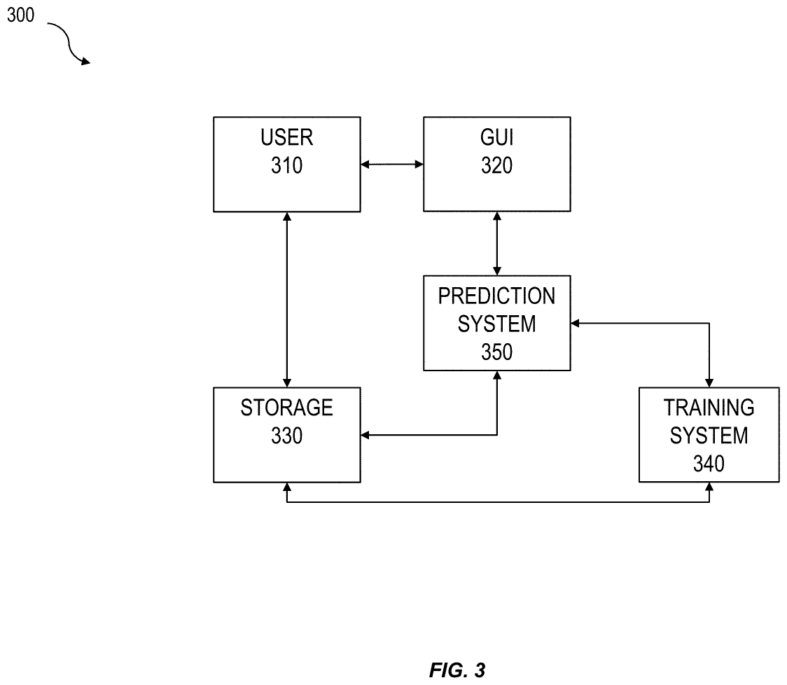

FIG. 3 is a system block diagram illustrating an example implementation of a system 300 for training, assessing, and deploying a set of resourcing models. System 300 can include graphical user interface (GUI) 320, storage 330, training system 340, and prediction system 350. By training and assessing multiple models under different resourcing levels and providing an intuitive representation of the performance of the models under the different resource constraints, the model most appropriate for a given operational constraint can be selected and deployed. As such, the performance of the models can be improved and computational resources, production time, and production costs can be saved.

GUI 320 can be configured to receive input from user 310. For example, the input can include a dataset Dₙ={x⁽¹⁾, . . . , x⁽ⁿ⁾} for training the set of models M={M₁, . . . , Mₖ}, where k is the number of models in the set of models. As another example, the input can include values TPᵥ, TNᵥ, FPᵥ, FNᵥ; counts TP_{c}, TN_{c}, FP_{c}, FN_{c}; and/or the like. As another example, the input can include constraints (e.g., a condition on a variable and/or the like) c_{h,r}^{(j)} on variables xₕ^{(j)} (e.g., columns and/or the like) of elements x^{(j)} (e.g., rows and/or the like) of the dataset Dₙ, where, for example, xₕ^{(j)}∈x^{(j)}=(x₁^{(j)}, . . . , xₕ^{(j)}, . . . , x_{d}^{(j)}), x^{(j)}∈Dₙ, where n is the number of entries (e.g., rows and/or the like) in the dataset, d is the dimension (e.g., number of columns and/or the like) of each dataset entry, j is an index indicating a value in the range {1, . . . , n} (e.g., an index pointing to a dataset entry and/or the like), h is an index indicating a value in the range {1, . . . , d} (e.g., an index pointing to a variable of a dataset entry and/or the like), and r is an index indicating a value in the range {1, . . . , number of constraints on the variable xₕ^{(j)}} (e.g., an index pointing to a constraint in the set of constraints on a variable and/or the like.

As another example, GUI 320 can be configured to receive user input specifying a training goal. For example, a training goal can include an indication of the output, performance, and/or the like of the set of models. For example, a set of models can be trained to optimize a first goal, such as optimizing impact (e.g., profit, revenue, and the like); optimize a first goal given a second goal, such as optimizing growth given break even impact, optimize cash flow given minimum investment, and/or the like. In some implementations, the boundary of feasible performance can determine all possible optimal points for M={M₁, . . . , Mₖ}.

Storage 230 can be configured to store (e.g., persist and/or the like), for example, inputs received from GUI 320 such as datasets Dₙ={x⁽¹⁾, . . . , x⁽ⁿ⁾}; values TPᵥ, TNᵥ, FPᵥ, FNᵥ; counts TP_{c}, TN_{c}, FP_{c}, FN_{c}; constraints c_{h,r}^{(j)} on variables xₕ^{(j)}; and/or the like. As will be discussed below, storage 230 can be configured to store sets of trained models. And storage 230 can be configured to store, for example, the performance of the sets of models, assessments of the performance of the sets of models, and/or the like. Storage 230 can include, for example, repositories of data collected from one or more data sources, such as relational databases, non-relational databases, data warehouses, cloud databases, distributed databases, document stores, graph databases, operational databases, and/or the like.

Training system 240 can be configured to train sets of models M={M₁, . . . , Mₖ} on datasets, such as Dₙ={x⁽¹⁾, . . . , x⁽ⁿ⁾}. Each model Mᵢ∈M can be trained on the entries x^{(j)} in the dataset Dₙ using, for example, learning algorithms, such as principal component analysis, singular value decomposition, least squares and polynomial fitting, k-means clustering, logistic regression, support vector machines, neural networks, conditional random fields, decision trees, and/or the like. In some cases, the sets of models can be trained on constrained variables xₕ^{(j)}∈x^{(j)}, where x^{(j)}∈Dₙ and the constraint includes c_{h,r}^{(j)} . In some cases, user input can be received specifying a new constraint value c_{h,r+1}^{(j)} and a new model Mₖ₊₁ can be generated. For example, the new model Mₖ₊₁ can be trained on the new constraint c_{h,r+1}^{(j)}.

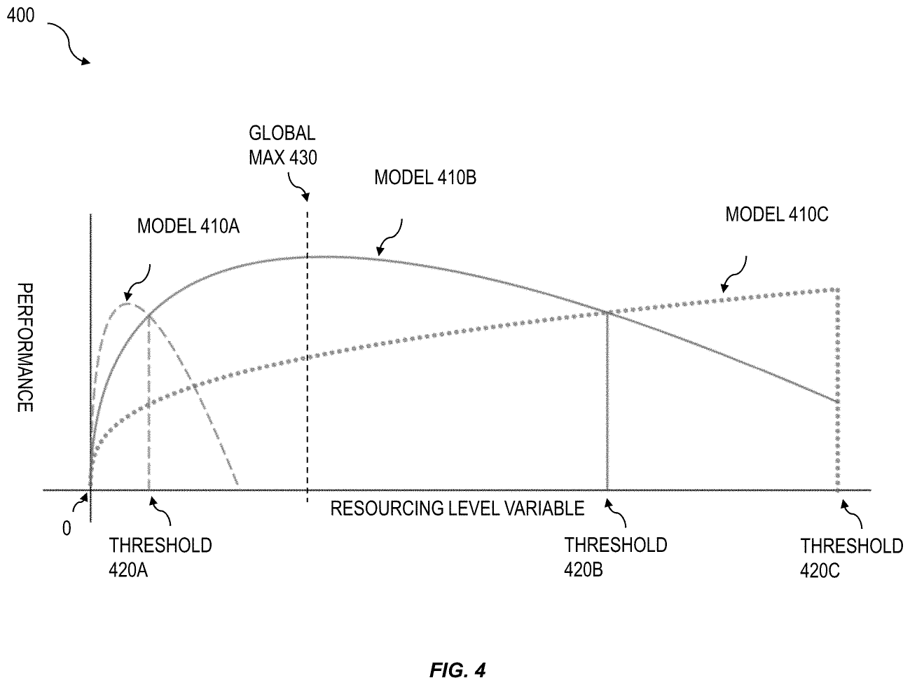

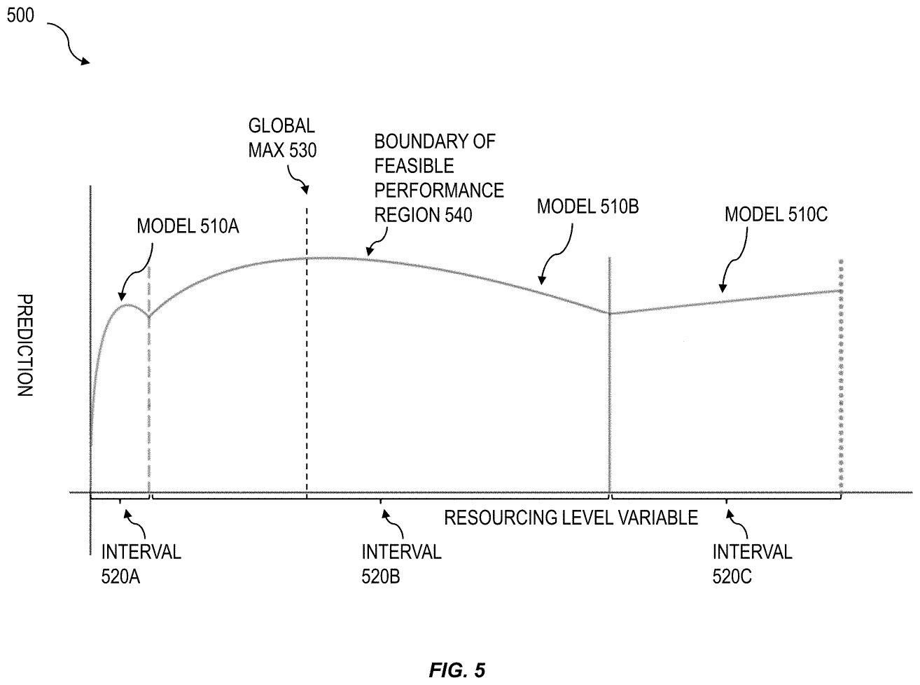

Prediction system 250 can be configured to assess the performance of sets of models, such as M={M₁, . . . , Mₖ}, and determine feasible performance regions. As will be discussed below with reference to FIG. 4 and FIG. 5, the feasible performance region can include a set of intervals I={(a₁, a₂), . . . , (aₚ₋₁, aₚ)}, where for a given interval (aᵢ, aᵢ₊ᵢ)∈I, aᵢ∈{a₁, . . . , aₚ₋₁} can include the start values of the intervals and aᵢ₊₁∈{a₂, . . . , aₚ} can include the end values of the intervals, such that for each interval (aᵢ, aᵢ₊₁)∈I, a model M₍ₐ_{ᵢ}_{,a}_{ᵢ₊ᵢ}₎∈M can provide optimal performance in the given interval (aᵢ, aᵢ₊₁). The optimally performing model M₍ₐ_{ᵢ}_{, a}_{ᵢ₊ᵢ}₎, for example, can be associated with and used for values of the variable within the interval (e.g., xₕ^{(j)}∈(aᵢ, aᵢ₊₁) and/or the like).

Following the above example, for each data set entry x^{(j)}∈Dₙ and for each value of a variable in each dataset entry (e.g., xₕ^{(j)}∈x^{(j)}), such that a₁≤xₕ^{(j)}≤aₚ, the performance of each model Mₗ∈M can be assessed by determining the output of each model Mₗ when given the variable xₕ^{(j)}, (e.g., Mₗ(xₕ^{(j)}) can be computed and/or the like). In some cases, the output of the model can include impact. After computing the output of each model Mₗ∈M over the values of the variable xₕ^{(j)} in each interval (aᵢ, aᵢ₊ᵢ)∈I, the feasible performance region can include the set of intervals I={(a₁, a₂), (aₚ₋₁, aₚ)} and, for each interval (aᵢ, aᵢ₊₁), the associated model M₍ₐ_{ᵢ}_{,a}_{ᵢ₊ᵢ}₎=Mₗsuch that Mₗ can include the optimally performing model in the interval (aᵢ, aᵢ₊₁). For example, the feasible performance region can include a map of intervals (aᵢ, aᵢ₊₁) to models M₍ₐ_{ᵢ}_{,a}_{ᵢ₊ᵢ}₎, such that Feasible Performance Region={(a₁, a₂): M₍ₐ_{₁}_{,a}_{₂}₎, . . . , (aₚ₋₁, aₚ): M₍ₐ_{_{p−1}}_{,a}_{ₚ}₎}.

FIG. 4 is a diagram illustrating an example visualization 400 of outputs provided by several models as a function of a resourcing variable. By training and assessing multiple models under different resourcing levels and providing an intuitive representation of the performance of the models under the different constraints, the model most appropriate for a given operational constraint can be selected and deployed. As such, the performance of the models can be improved and computational resources, production time, and production costs can be saved.

The visualization 400 can include, for example, a graph of performance as a function of the resourcing variable. In some cases, performance can include impact. The output of each model can be graphed. FIG. 4 illustrates the output of three models, model 310A, M_{A}, model 310B, M_{B}, and model 310C, M_{C}. As illustrated in FIG. 4, below threshold 420A the performance of model 410A is optimal, between threshold 420A and threshold 420B the performance of model 410B is optimal, and after threshold 420B the performance of model 410C is optimal. The intervals can be defined as I={(a₁, a₂), (a₂, a₃), (a₃, a₄)}, where a₁=0, a₂=threshold 420A, a₃=threshold 420B, a₄=threshold 420C. Then, the feasible performance region can be

$$Feasible Performance Region = \{ ( {a}_{1} , {a}_{2} {\text{):} \text{M}}_{A} , ( {a}_{2} , {a}_{3} {\text{):} \text{M}}_{B} , ( {a}_{3} , {a}_{4} {\text{):} \text{M}}_{C} \}$$

FIG. 5 is a diagram illustrating an example visual representation 500 of a feasible performance region. By training and assessing multiple models under different resourcing levels and providing an intuitive representation of the performance of the models under the different resourcing, the model most appropriate for a given operational constraint, business impact, or strategy can be selected and deployed. As such, the performance of the models can be improved and computational resources, production time, and production costs can be saved.

Visual representation 500 can include, for example, feasible performance region boundary 540. As described above with reference to FIG. 4, the feasible performance region can include, for example, interval 520A (a₁, a₂) of resourcing associated with model 510A M_{A}, interval 520B (a₂, a₃) of resourcing associated with model 520B M_{B}, and interval 520C (a₃, a₄) of resourcing associated with model 510C M_{C}. Feasible performance region boundary 540 can easily represent the performance of a set of models, for example, over the entire domain of possible resource levels. To the user, feasible performance region boundary 540 can represent the performance of the set of models (e.g., M={M_{A}, M_{B}, M_{C}} and/or the like) and the set of models can be treated as a single model. As such, some implementations of the current subject matter can facilitate user interaction with a set of models M={M₁, . . . , Mₖ} by treating the set of models as a single model M* (e.g., an ensemble model and/or the like). For example, with M={M_{A}, M_{B}, M_{C}}, the interval I={(a₁, a₂), (a₂, a₃), (a₃, a₄)}, and the feasible performance region {(a₁, a₂): M_{A}, (a₂, a₃): M_{B}, (a₃, a₄): M_{C}}, the single model M* can be defined piecewise such that,

$${M}^{*} ( {x}_{h}^{( j )} ) = \{ {M}_{A} ( {x}_{h}^{( j )} ) , {a}_{1} \leq {x}_{h}^{( j )} < {a}_{2} {M}_{B} ( {x}_{h}^{( j )} ) , {a}_{2} \leq {x}_{h}^{( j )} < {a}_{3} {M}_{C} ( {x}_{h}^{( j )} ) , \\ \& {a}_{3} \leq {x}_{h}^{( j )} \leq {a}_{4}$$

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural language, an object-oriented programming language, a functional programming language, a logical programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive trackpads, voice recognition hardware and software, optical scanners, optical pointers, digital image capture devices and associated interpretation software, and the like.

In the descriptions above and in the claims, phrases such as “at least one of” or “one or more of” may occur followed by a conjunctive list of elements or features. The term “and/or” may also occur in a list of two or more elements or features. Unless otherwise implicitly or explicitly contradicted by the context in which it is used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” In addition, use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A method comprising:
receiving data characterizing a population and a target trait characteristic for selecting candidates from the population, the population including members and each member of the population including a respective trait classifiable into one of two or more classes;
segmenting the population into at least a first subpopulation and a second subpopulation, the segmenting such that all members of the first subpopulation are part of a first class of the two or more classes, and all members of the second subpopulation are part of a second class of the two or more classes;
selecting, from the first subpopulation and using a first model, a first number of candidates from the first subpopulation, the first number of candidates selected according to the target trait characteristic, the first model trained using a first training population in which all members of the first training population are part of the first class of the two or more classes; and
selecting, from the second subpopulation and using a second model, a second number of candidates from the second subpopulation, the second number of candidates selected according to the target trait characteristic, the second model trained using a second training population in which all members of the second training population are part of the second class of the two or more classes.

2. The method of claim 1, wherein the population includes members of a protected class.

3. The method of claim 1, wherein the respective trait is a characteristic of a person.

4. The method of claim 3, wherein the trait is classifiable into only the first class or the second class.

5. The method of claim 3, wherein the trait is classifiable into three or more classes.

6. The method of claim 5, wherein the segmenting further includes segmenting the population into at least a third subpopulation, wherein all members of the third subpopulation are part of a third class of the three or more classes; and
wherein the method further comprises selecting, from the third subpopulation and using a third model, a third number of candidates from the third subpopulation, the third number of candidates selected according to the target trait characteristic, the third model trained using a third training population in which all members of the third training population are part of the third class of the three or more classes.

7. The method of claim 1, wherein the target trait characteristic includes a maximum allowed number of one of the first class and/or the second class, a minimum allowed number of the first class and/or the second class, or a ratio between at least the first class and the second class.

8. The method of claim 1, wherein the first model includes a set of submodels, each submodel trained using a respective different resource constraint.

9. The method of claim 8, wherein selecting the first number of candidates includes receiving a resource level and selecting a corresponding submodel from the set of submodels forming the first model, the selected submodel associated with the received resource level.

10. The method of claim 1, wherein the selecting the first number of candidates is further according to an impact function.

11. The method of claim 10, wherein the impact function characterizes maximizing profits for a business, maximizing growth for the business, maximizing revenue for the business, and/or minimizing resource consumption for the business.

12. The method of claim 1, wherein the first model is continuously trained, and the method further comprises:
receiving user feedback regarding the selected first number of candidates and retraining the first model using the user feedback and the selected first number of candidates.

13. The method of claim 1, wherein each member of the population includes a second respective trait classable into two or more additional classes including a third class and a fourth class, and wherein the method further comprises:
segmenting the first subpopulation into a third subpopulation and a fourth subpopulation, the segmenting such that all members of the third subpopulation are part of the third class, and all members of the fourth subpopulation are part of the fourth class;
segmenting the second subpopulation into a fifth subpopulation and a sixth subpopulation, the segmenting such that all members of the fifth subpopulation are part of the third class, and all members of the sixth subpopulation are part of the fourth class;
wherein the selecting, from the first subpopulation and using the first model, of the first number of candidates from the first subpopulation includes selecting, from the third subpopulation, a third number of candidates according to a second target trait characteristic, and selecting, from the fourth subpopulation, a fourth number of candidates according to the second target trait characteristic, wherein a total number of the third number of candidates and the fourth number of candidates equals the first number of candidates.

14. The method of claim 13, wherein the first model includes a set of submodels, each submodel trained using a respective different resource constraint,
wherein selecting the third number of candidates includes receiving a resource level and selecting a corresponding submodel from the set of submodels forming the first model, the selected submodel associated with the received resource level, and
wherein selecting the fourth number of candidates includes selecting the second corresponding submodel from the set of submodels forming the first model.

15. A system comprising:
at least one data processor; and
memory storing instructions which, when executed by the at least one data processor, causes the at least one data processor to perform operations comprising:
receiving data characterizing a population and a target trait characteristic for selecting candidates from the population, the population including members and each member of the population including a respective trait classifiable into one of two or more classes;
segmenting the population into at least a first subpopulation and a second subpopulation, the segmenting such that all members of the first subpopulation are part of a first class of the two or more classes, and all members of the second subpopulation are part of a second class of the two or more classes;
selecting, from the first subpopulation and using a first model, a first number of candidates from the first subpopulation, the first number of candidates selected according to the target trait characteristic, the first model trained using a first training population in which all members of the first training population are part of the first class of the two or more classes; and
selecting, from the second subpopulation and using a second model, a second number of candidates from the second subpopulation, the second number of candidates selected according to the target trait characteristic, the second model trained using a second training population in which all members of the second training population are part of the second class of the two or more classes.

16. The system of claim 15, wherein the population includes members of a protected class.

17. The system of claim 15, wherein the respective trait is a characteristic of a person, wherein the trait is classifiable into three or more classes, wherein the segmenting further includes segmenting the population into at least a third subpopulation, wherein all members of the third subpopulation are part of a third class of the three or more classes, and
wherein the operations further comprises selecting, from the third subpopulation and using a third model, a third number of candidates from the third subpopulation, the third number of candidates selected according to the target trait characteristic, the third model trained using a third training population in which all members of the third training population are part of the third class of the three or more classes.

18. The system of claim 15, wherein the target trait characteristic includes a maximum allowed number of one of the first class and/or the second class, a minimum allowed number of the first class and/or the second class, or a ratio between at least the first class and the second class.

19. The system of claim 15, wherein the first model includes a set of submodels, each submodel trained using a respective different resource constraint.

20. A non-transitory computer readable medium storing computer instructions which, when executed by at least one data processor forming part of at least one computing system, causes the at least one data processor to perform operations comprising:
receiving data characterizing a population and a target trait characteristic for selecting candidates from the population, the population including members and each member of the population including a respective trait classifiable into one of two or more classes;
segmenting the population into at least a first subpopulation and a second subpopulation, the segmenting such that all members of the first subpopulation are part of a first class of the two or more classes, and all members of the second subpopulation are part of a second class of the two or more classes;
selecting, from the first subpopulation and using a first model, a first number of candidates from the first subpopulation, the first number of candidates selected according to the target trait characteristic, the first model trained using a first training population in which all members of the first training population are part of the first class of the two or more classes; and
selecting, from the second subpopulation and using a second model, a second number of candidates from the second subpopulation, the second number of candidates selected according to the target trait characteristic, the second model trained using a second training population in which all members of the second training population are part of the second class of the two or more classes.
